(19) United States
(12) Patent Application Publication
(10) Pub. No.: US 2007/0039060 A1
(43) Pub. Date: Feb. 15, 2007

(54) Methods and systems for programming secure data into programmable and irreversible cells

(76) Inventors: Georges E. Jamieson, Dallas, TX (US); Anne-Clotilde Mascart, Dallas, TX (US); Jeanne M. Rickert, Richardson, TX (US); Douglas Patrick Snead, Corinth, TX (US); Chen-Yi Shannon Su, Dallas, TX (US)

Correspondence Address: TEXAS INSTRUMENTS INCORPORATED, P O BOX 655474, M/S 3999, DALLAS, TX, 75265, US

(21) Appl. No.: 11/203,500

(22) Filed: Aug. 12, 2005

(51) Int. Cl. G06F 11/00

(52) U.S. Cl. 726/34

(57) ABSTRACT

Methods and systems for programming secure data into programmable and irreversible memory cells included in electronic circuitry are provided. In general, the secure data is stored in one or more arrays integrated into or associated with an electronic device such as an IC. According to a disclosed method embodying the invention, a programmable and irreversible memory cell array has a control bit for indicating the program state of the array. The method includes reading the control bit of the array to identify a programmable state, loading and programming secure data, read-protecting and write-protecting the array. The control bit is programmed to indicate the non-programmable state of the programmed array. Aspects of the invention include monitoring for incorrectly programmed or unprotected secure data, and in the event such problems arise, programming all cells of the array in order to scuttle the programmed secure data and/or the device information specific to the IC to place the device into an invalid state. According to other aspects of the invention, preferred embodiments of the systems and methods include serially programming secure data into multiple arrays.

### TECHNICAL FIELD

The invention relates to the manufacturing and testing of integrated circuitry (ICs). More particularly, the invention relates to methods and systems for programming secure data into programmable and irreversible memory cells in or associated with ICs.

### BACKGROUND OF THE INVENTION

In the electronic arts concerned with the design, manufacture, and testing of integrated circuitry, it is known to program electronically programmable and irreversible memory cells, such as electronic fuses or EPROM, for example, in order to permanently store information within the circuitry. Commonly, one or more arrays of programmable and irreversible memory cells, such as e-fuses, may be used to store reference data such as identification, configuration, or encryption data, in addition to various other types of information depending on the application. In some cases, it is desirable to store confidential data for use by an electronic device associated with, or integrated with, the memory cells. For example, it may be desirable from a commercial standpoint for a manufacturer of semiconductor devices to prevent customers and/or users from accessing certain information stored on the devices. The reverse is also true. A customer may desire the manufacturer to include confidential data on devices with assurances that the data will not be compromised. It may also be desirable to prevent access to secure data during certain stages of manufacture and testing, and even on discarded defective devices. For example, memory cells such as electronic fuses do not always program, or “blow”, as planned due to manufacturing defects or the application of insufficient voltage during programming. Thus, the resulting partially programmed devices may contain some or even most of the secure data intended to be programmed, yet nevertheless require disposal as defective devices. Those with less-than honorable intentions could potentially analyze such devices in order to recover the secure data for their own purposes. Such considerations present challenges in providing methods and systems for programming secure data into arrays of programmable and irreversible memory cells in an IC in such a way that the contents of the secure data is not compromised after successful programming, through intercession during manufacture and testing, or recovered from discarded defective devices.

Thus, there is a need in the arts for methods and systems of programming and verifying the successful storage of secure data in programmable and irreversible memory cell arrays, while assuring that the stored information itself is not compromised either during or after programming.

### SUMMARY OF THE INVENTION

The term “secure data” is used herein to refer to confidential data intended to be associated with a particular IC but remain inaccessible to the user. In carrying out the principles of the present invention, in accordance with preferred embodiments thereof, methods for irreversibly programming memory cell arrays, also referred to herein as “cells” or “arrays”, with secure data are provided. In general, the secure data is stored in one or more arrays integrated into or associated with an electronic device such as an IC. At least one array contains specific device information, including a control bit cell used to record whether the device is untested, subject to retesting, or defective, i.e., programmable or nonprogrammable. The control bit cell may also have additional functionality such as providing read/write-protection to the array(s) used to store secure data. Alternatively, read/write-protection may be implemented in sub-arrays where the secure data resides.

According to an aspect of the invention, a method is described for programming secure data into a programmable and irreversible memory array associated with an IC. The IC has a control bit for indicating the program state of the IC. The method includes steps for reading the control bit to identify a programmable state of the IC. Secure data is loaded into a programmable and irreversible memory array and tested. The array containing the loaded secure data is read-protected. In a further step, the read-protect status of the array containing the loaded secure data is tested. Steps are also included for write-protecting the array containing the loaded secure data, and for testing the write-protect status. The control bit is programmed to indicate the non-programmable state of the programmed array, and finally, the control bit itself is write-protected, thereby completing the permanent programming of the secure data into the programmable and irreversible memory array.

According to another aspect of the invention, preferred methods of the invention also include steps for, subsequent to loading secure data, identifying incorrect loaded secure data in the programmable and irreversible memory array and thereafter reiterating the loading and testing steps before continuing with the further steps as described herein.

According to another aspect of the invention, additional method steps are included subsequent to read-protecting the secure data, for identifying non-read-protected secure data in the programmable and irreversible memory array and thereafter programming all cells of the array in order to scuttle the loaded secure data.

According to yet another aspect of the invention, a programmable irreversible memory system is described in which, an electronic device having one or more associated arrays of programmable electronic memory includes at least one cell for accepting and storing secure data. One or more read-protect cell, and one or more write-protect cell are provided for activation to permanently prevent reading and writing data of the secure data cells. A control bit cell is provided, for upon activation permanently indicating the programmed state of the array.

According to still another aspect of the invention, preferred embodiments include the programming of secure data into multiple arrays of programmable and irreversible memory cells associated with the same device.

The invention has advantages including but not limited to providing systems and methods for programming secure data into programmable and irreversible memory. The techniques of the invention ensure that the secure data is correctly written and stored and that the secure data is not compromised after programming, while stored on programmed devices, or from defective devices discarded during manufacturing and testing. These and other features, advantages, and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a process flow diagram illustrating an overview of the programming of secure data, into arrays of programmable and irreversible memory cells, read-protecting, and write-protecting cells, according to preferred embodiments of the invention;

FIG. 2 is a process flow diagram showing a more detailed view of steps in programming secure data into programmable and irreversible memory arrays according to the preferred embodiment of the invention shown and described with reference to FIG. 1;

FIG. 3 is a process flow diagram showing a more detailed view of steps in programming data into cells in programmable and irreversible memory arrays according to the preferred embodiment of the invention shown and described with reference to FIG. 1;

FIG. 4 is a process flow diagram showing a more detailed view of steps in read-protecting the cells according to the preferred embodiment of the invention shown and described with reference to FIG. 1; and

FIG. 5 is a process flow diagram showing a more detailed view of steps in repairing failed programming of secure data into the programmable and irreversible memory arrays according to the preferred embodiment of the invention shown and described with reference to FIG. 1.

References in the detailed description correspond to like references in the various drawings unless otherwise noted. Drawings depicting steps in methodologies are necessarily conceptual in nature and are presented for describing the essentials of the invention. The drawings are not intended to be interpreted in a physically limiting sense as literally describing every possible alternative embodiment of the invention in every detail. Descriptive and directional terms used in the written description such as first, second, top, bottom, path, etc., refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DETAILED DESCRIPTION OF PREFERRED EMBODIMENTS

It should be understood throughout the description that the implementation of the invention, from a user's perspective, is preferably embedded in a Tester Operating System (TOS). In that the software is binary compiled code, the test flow is protected inside the software and secure data is never available outside of the TOS software. The particulars of the TOS and of how the secure data is made available for programming by the TOS are not part of the invention and are not discussed herein. The practice of the invention, and the description herein, begins based on the assumption that the secure data has been obtained by the TOS and that the TOS maintains a temporary copy of the secure data in volatile memory. During programming, if the read-protection step fails and/or programming of the control bit cell fails, all cells in the arrays containing the secure data are overwritten to “programmed” states, e.g. all ones, or all zeros, or any combination of ones and zeros depending on the technology, to ensure that no portion of secure data can be read from the device after the user of the TOS regains control of the device. If any of the intermediate steps fail, all cells in the array containing the control bit cell are overwritten with invalid data or all “programmed” states, e.g., all ones, or all zeros, or any combination thereof, depending on the technology to ensure that the device is in an invalid state. Overwriting the data and/or overwriting the device information specific to the IC maintains the integrity of the secure data in the event of unsuccessful programming or read/write protection failure.

The invention is practiced in the context of electronic circuitry, referred to in general as a “device” or “IC”, which includes electronic programmable and irreversible memory arrays, such as electronic fuses, for storing information concerning the circuitry. Those skilled in the arts will recognize that multiple IC assemblies or combinations of devices may also be used. The circuit should have a memory cell designated as the “control bit”. The control bit is used to mark the state of the circuit in order to determine whether or not the circuit could benefit from the practice of the invention based on various conditions such as, new device, defective unit, or re-screen of a previously tested device. The control bit cell must be associated with the programmable and irreversible memory array where device information specific to the IC is programmed. The control bit may also have additional functionality such as, upon programming, disabling the read/write access to the arrays that contain the secure data. If the control bit is not provided with read/write-protection functionality, the arrays on the IC where the secure data is to reside must have separate read- and write-protection cells.

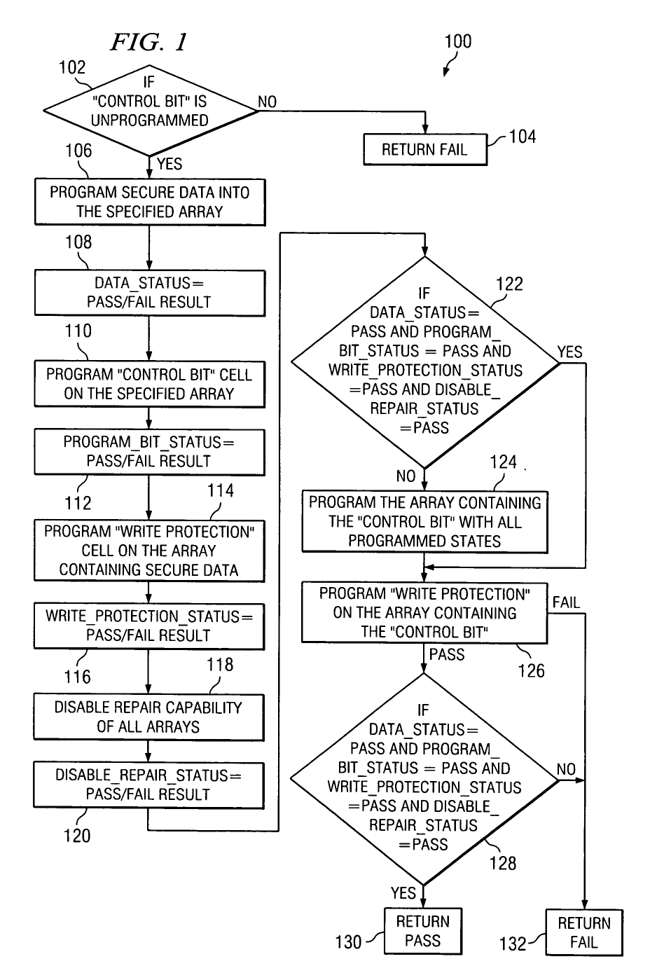

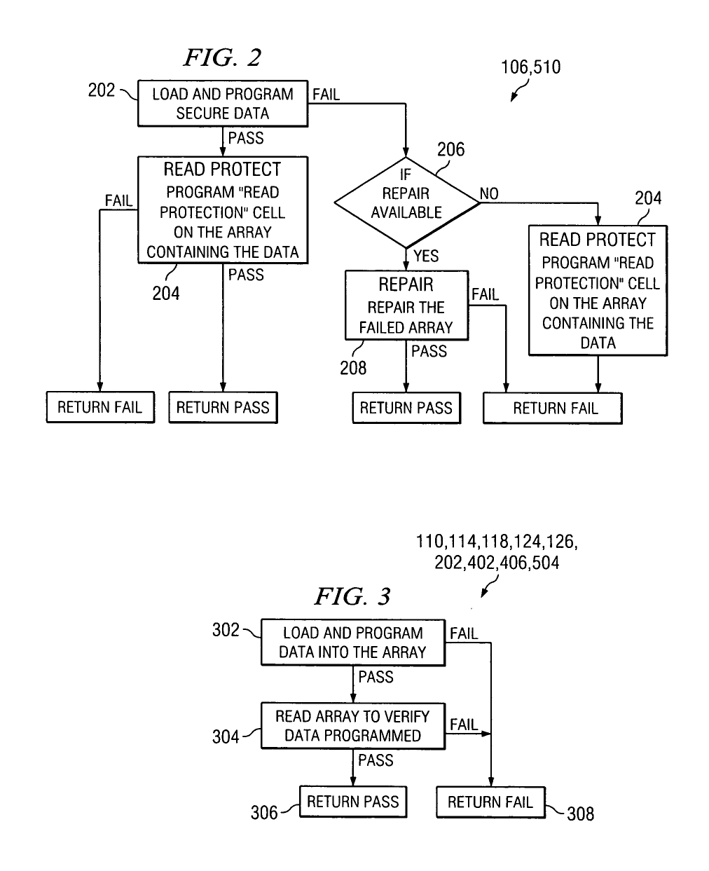

The programming of the secure data, the control bit, and the implementation of read-protection and write-protection must be performed in a particular order to ensure the highest quality of the test and the integrity of the secure data. Throughout this process flow, it must be ensured that the secure data is programmed correctly into the programmable and irreversible memory arrays on the IC and that all access to the secure data on the IC is disabled. A general overview of the test flow and the protection steps in implementing the methods and systems of the invention is shown in FIGS. 1 through 5. FIG. 1 provides an overall view of the invention and FIGS. 2 through 5 provide additional illustrations of particular aspects of the invention. The interaction of the operations shown in the figures taken together as a whole should be born in mind when referring to any single figure or when considering any of the potential variations within the scope of the invention.

FIG. 1 illustrates the process flow for programming secure data into the programmable and irreversible memory arrays of an IC and read-protecting and write-protecting that secure data within the IC. As shown at step 102, the process flow 100 begins by determining whether or not the control bit cell is in the “programmable” state. If the control bit indicates that the IC is “nonprogrammable”, as in the case of a previously programmed or defective device, the test flow is exited as shown at arrow path 104. If the control bit indicates that the device is programmable, the process proceeds to step 106 for programming the secure data into one or more specified arrays.

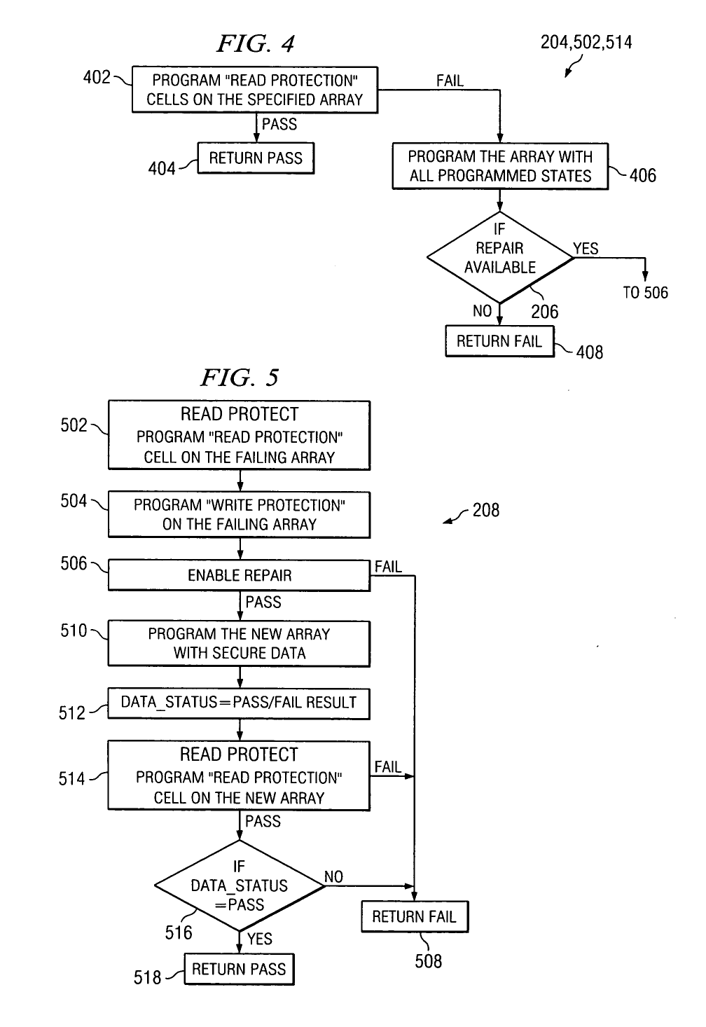

The programming of the secure data 106 involves many steps including loading and programming, testing, in some cases re-loading and re-programming if necessary, read-protecting, testing the read-protection, and potentially “repairing” the IC by storing the secure data in an alternate location if the initial programming fails. The details and alternatives of this programming step (106) are further described below with reference primarily to FIG. 2. The loading and verification of memory cell arrays is in turn depicted in more detail in FIG. 3, and the read-protect and repairing steps are also described in more detail below with reference to FIGS. 4 and 5 respectively. Continuing to focus on the overall process flow 100 shown in FIG. 1, as shown at box 108, the PASS/FAIL result of the step (106) to program the secure data is preferably temporarily stored for later use. Following the programming of the secure data 106, the control bit cell is programmed 110, as detailed below with reference to FIG. 3. It should be understood that the programming of the control bit 110 is preferably performed at this point in the flow regardless of whether the previous programming step in the flow, programming the secure data 106, succeeded or failed. In either case, in the event of re-screening, i.e., reiteration of step 102, the programmed state of the control bit cell indicates that the particular array has already experienced programming. As indicated at box 112, the PASS/FAIL result of the step to program the control bit 110 is preferably temporarily stored for later use.

The invention may be implemented with multiple arrays each having a dedicated read- and/or write-protection cell, in which case the following step 114 applies. Following the attempt to program the control bit cell (110), the write-protection cells on all the arrays containing the secure data are programmed 114, as further detailed in FIG. 3. The programming of the write-protection cells 114 at this juncture is performed regardless of whether or not the previous two programming steps in the flow (106, 110) succeeded or failed. Programming the write-protection cells 114 prevents the secure data from being modified. Preferably, the PASS/FAIL result of the step to program the write-protection cells is temporarily stored by the TOS for later use 116. The invention may also be practiced with arrays in which the control bit is also the overall read- and/or write-protection cell and no individual write-protection cells are provided on the array(s), in which case step 114 is omitted.

Some ICs are equipped with repair capabilities such as redundant programmable arrays that may be substituted for arrays which fail to program properly. When practicing the invention with such ICs, the unused repair capabilities, e.g., the accessibility of the unused redundant or unused “spare” arrays, must be disabled after programming 118. Generally, this may be accomplished by programming one or more cells, as shown and discussed with reference to FIG. 3, preventing access to potential repairs after programming. This precaution prevents activation of unused “repair” arrays after programming is completed. Preferably, the PASS/FAIL result of the step 118 to disable the unused repair capability is temporarily stored by the TOS for later use 120. In IC's lacking this type of capability, steps 118 and 120 may be omitted without departure from the invention.

As indicated at decision diamond 122, an additional processing step may be performed in the event any of the programming steps, 106, 110, 114, 118, has failed. Preferably, if any of these programming steps fails, all cells of the array(s) containing the control bit(s) are programmed with all “programmed” states 124, e.g., set to “ones”, or set to “zeros”, or any combination for obliterating the secure data depending on the technology, using the flow shown in FIG. 3. The objective of this step is to overwrite the secure data and/or the device information specific to the IC in the programmable and irreversible memory array(s) as much as possible such that the failing device is in an invalid state. In this way secure data which may have been programmed or partially programmed in previous steps may be obliterated. Providing this step for scuttling an unsuccessful programming attempt safeguards the secured data from potential efforts to recover it from discarded devices. For example, assume that an attempt was made to program the sequence of secure data 01010101 into an array of e-fuses used as programmable and irreversible memory. Further, assume that an incorrect programmed result of 00010101 was obtained, or that the correct result was programmed, but not successfully read-protected. Subsequently attempting to program all elements of the array may produce a result of 11111111, or 1011111, or some other result, depending on the nature of the defect in the device or process, but in any case, the secure data or portion of secure data in the array would be obliterated, ensuring confidentiality. This is but one illustrative example of how a method of the invention may be performed.

Again referring to FIG. 1, preferably the write-protection cell, if available, on the programmable and irreversible memory array containing the control bit cell is next programmed, step 126, using the flow shown in FIG. 3. If this step 126 fails to write-protect the array containing the control bit cell, all the cells on the array are programmed to all “programmed” states, e.g. all “ones”, or all “zeros”, or any obliterating combination thereof, the device is in an invalid state. As shown in decision diamond 128, if this step 126, or any of previous programming steps 106, 110, 114, 118, resulted in a failure, a record of which is temporarily stored at steps 108, 112, and 116, 120, respectively, a FAIL status is returned 132 for the device under test. If, on the other hand, this step 126 and all of the earlier programming (e.g., 106, 110, 114, 118) steps passed, the IC under test is good and a PASS status is returned 130. At this point the control of the device may be returned by the TOS to the user for further testing or programming as generally known in the arts, or for the application of an additional implementation of the invention elsewhere on the IC or an associated memory chip.

FIG. 2 illustrates an example of the preferred flow 106 and 510 for programming the secure data into the programmable and irreversible memory arrays of the IC. The “load and program secure data” operation, box 202, is itself described in more detail below in the discussion of FIG. 3. If the programming step 202 is successful, the memory cell array containing the secure data is read-protected if a separate read-protect cell is available 204, which is in turn described in more detail below with reference to FIG. 4. In this event the PASS/FAIL result is returned from the read-protect operation 204, as shown. On the other hand, if the programming step 202 has failed, there are potential alternatives 206 according to the implementation of the invention. Preferably, a determination is made within the TOS of whether or not the device supports replacement of a programmable and irreversible memory array. This may be accomplished in various ways by those skilled in the arts. If the device supports repair, for example by provision of unused redundant or “backup” fuse arrays in a system using e-fuses, further steps may be taken to work around the failing e-fuse array by performing the “repair” operation 208 further described below with reference to FIG. 5. In this instance, a PASS/FAIL result may be returned from the repair operation 208. In an alternative embodiment, in which the device does not support such repair, the flow proceeds to the step of read-protecting if a separate read-protect fuse is available 204 the e-fuse array containing the secure data, also shown in FIG. 4. Of course, a similar procedure would apply in systems using programmable and irreversible memory arrays other than, or in addition to fuses.

FIG. 3 represents the programming of data into an irreversible memory array of a device as referred to elsewhere herein. Those skilled in the arts will appreciate that the essentials of this process are described and that the details regarding the programming the cells of an array are highly dependent upon the characteristics of the individual device. Typically, a template pattern is modified to reflect the data that is to be programmed into the array. In some instances, the template pattern may also be modified to reflect the location within the array where the data is to be programmed. The terms “template pattern” or “pattern” reference a set of information, e.g., data and/or instructions concerning how to program the secure data into the particular IC. For the purposes of this invention, the modified pattern is maintained in temporary memory and is never made available outside of the TOS. Once the pattern has been modified, the TOS transfers that pattern to the device and programs the data into the device by programming selected cells 302. The details surrounding the modifying and transferring of the template pattern are not essential to the invention, and various alternative techniques exist for doing so. For some technologies, the data is located on a single array; therefore, the pattern only needs to be modified with the data to be programmed. For other technologies, the data is separated into distinct pieces and each piece is located on a different array, therefore, the pattern needs to be modified with the piece of the data to be programmed and the address of the array where that piece of the data needs to be programmed. If the data consists of distinct pieces, the flow shown is executed in a loop with an iteration of the loop for each piece to be programmed. This step of the flow may utilize a single template pattern or multiple template patterns depending on the technology of the device.

If the loading step 302 fails, the step returns with a FAIL status 308. If the loading step 302 succeeds, the TOS reads 304 the secure data from the loaded cells and verifies the correctness of the secure data. Preferably, determining the correctness of the secure data is not limited to verifying that the correct secure data is read back from the device. For example, in a system using e-fuse arrays, the TOS may also take into account the result of a post-reading from the programmed electrical fuses to ensure that the fuses are blown with high enough margins to ensure the reliability of the programming. This step returns the PASS/FAIL result 306, 308 based on the read-back verification 304.

Now referring primarily to FIG. 4, the process 204, 502 and 514 for programming the read-protection cell of the array of the device is further described. If the memory cell array has a dedicated read-protection cell, the read-protection cell on the array is preferably programmed 402 using the steps described above and shown in FIG. 3. In this instance, the read-back verification (that occurs at step 304) could be expected to read all “unprogrammed” state, e.g., all “zeros”, or all “ones”, or any combination depending on the technology. If this step 402 succeeds, a status of PASS is returned 404. If this step 402 fails, all cells of the array are programmed, e.g., all “ones”, or all “zeros”, or any combination depending on the technology 406. Programming all cells of the programmable and irreversible memory array, as described, preferably uses the flow described with reference to FIG. 3. Programming all cells of the array 406 overwrites the secure data, preventing the secure data or portion of secure data on the unprotected array from being recovered from the device. As mentioned elsewhere herein, some ICs may be equipped with a repair capability for replacing arrays which fail to program. Regardless of the PASS/FAIL result of this particular step 406, as shown at decision diamond 206 in FIG. 4, in practicing the invention with such an IC, the repair capability may be enabled 506 in FIG. 5 and implemented as further described in FIG. 5. In the event if the repair capability is available, a PASS/FAIL status is returned from 508 and 518 in FIG. 5, and TOS temporarily stores the result in 108 in FIG. 1. In the event this capability does not exist, a status of FAIL is returned 408 since the objective of the step was to read-protect the secure data stored in the array and that objective was not met. If a separate read-protect cell is not available, as in the case where an IC may use a single cell such as the control bit to provide read-protection, read-protection may be engaged after the programming of all secure data, as with programming the control bit cell.

FIG. 5 illustrates the flow 208 for repairing a failing programmable and irreversible memory array on the device for use where such an option is available. If the effort to program the secure data into the device is unsuccessful 202, and the device supports the replacement of the failing array, then this step may be performed. As shown at step 502, the repair process preferably includes the programming of the read-protection fuse on the failing e-fuse array to prevent the partially programmed secure data within the IC's failing e-fuse array from being compromised as described above with reference to FIG. 4. As shown at step 504, the repair process preferably includes the programming of the write-protection fuse on the failing array to prevent the partially programmed secure data within the IC's failing array from being reused using the flow described in FIG. 3. Regardless of the result of the previous steps (502 and 504), the TOS enables the repair capability on the IC, 506. In general terms, this step comprises programming specific cells to enable the replacement of the failing array. The specifics of this operation are not within the scope of description and may indeed be the subject of additional systems, methods, techniques, and/or patents held by Texas Instruments Incorporated. The details of this operation are dependant upon the technology and design of the IC. If the replacement of the failing array is not available, a status of FAIL is returned 508. Otherwise, the repair flow continues to step 510, programming the secure data into the substitute array using the process described elsewhere herein (FIG. 3). Preferably, the PASS/FAIL result from this step is temporarily stored 512 for later use. Regardless of whether the programming 510 passed or failed, the read-protection cell, if available, on the new array is programmed 514 using the flow described with reference to FIG. 4. If this step passes and the previous programming step (510) also passed, then a status of PASS is returned 516. If this step fails or if the previous programming step (510) failed, then a status of FAIL is returned 508. The result is temporarily stored 108 and the process of FIG. 1 continues at step 110. Of course, in some devices, where multiple repairs are available, if either or both steps 510 and 514 fail, steps 506 to 514 may be reiterated.

The methods and systems of the invention provide advantages including but not limited to, protecting secure data by ensuring that secure data is never available outside of the TOS software, providing irreversible read/write-protection to the programmable memory arrays containing secure data before returning control to the TOS user. If only one control bit cell is provided on the IC and individual read-protection is available, the secure data are overwritten if the read-protection fails and/or the programming of the control bit cell fails. If any step of loading, programming, or read/write-protection of secure data fails, or disabling the repair capability of ICs so equipped, all cells on the array(s) containing the control bit cell(s) are programmed with all “programmed” states. While the invention has been described with reference to certain illustrative embodiments, the methods and systems described are not intended to be construed in a limiting sense. Various modifications and combinations of the illustrative embodiments as well as other advantages and embodiments of the invention will be apparent to persons skilled in the arts upon reference to the drawings, description, and claims.

We claim:

1. In an electronic device having at least one associated programmable and irreversible memory cell array, the array having a control bit cell for indicating its program state, a method of programming secure data into the array comprising the steps of:
(a) reading the control bit cell of the array to identify a programmable state of the array;
(b) programming secure data into the array;
(c) testing the secure data programmed in the array;
(d) read-protecting the array containing the programmed secure data;
(e) testing the read-protected status of the array containing the programmed secure data;
(f) write-protecting the array containing the programmed secure data;
(g) testing the write-protected status of the array containing the programmed secure data;
(h) programming the control bit to indicate the non-programmable state of the programmed array;
(i) testing the control bit status;
(j) write-protecting the control bit; and
(k) testing the write-protected status of the control bit; thereby permanently programming the secure data into the programmable and irreversible memory cell array.

2. A method according to claim 1 further comprising the step of identifying incorrect programmed secure data in the array; and
thereafter programming all cells of the array containing secure data, thereby overwriting the secure data.

3. A method according to claim 1 further comprising the step of identifying incorrect programmed secure data in the array; and
thereafter programming all cells of the array containing the control bit cell, thereby overwriting the secure data.

4. A method according to claim 1 further comprising the step of identifying unprotected programmed secure data in the array containing secure data; and
thereafter programming all cells of the array, thereby overwriting the secure data.

5. A method according to claim 1 further comprising the step of identifying unprotected programmed secure data in the array; and
thereafter programming all cells of the array containing the control bit cell, thereby overwriting the secure data.

6. A method according to claim 1 further comprising the step of identifying incorrect control bit data in the array; and
thereafter programming all cells of the array containing the control bit cell, thereby overwriting the secure data.

7. A method according to claim 1 further comprising the step of identifying incorrect control bit data in the array; and
thereafter programming all cells of the array containing the control bit cell, thereby overwriting the device information specific to the IC placing the device in an invalid state.

8. A method according to claim 1 further comprising the step of identifying non-write-protected control bit data; and
thereafter programming all cells of the array containing the control bit cell, thereby overwriting the secure data.

9. A method according to claim 1 further comprising the step of identifying non-write-protected control bit data; and
thereafter programming all cells of the array containing the control bit cell, thereby overwriting the device information specific to the IC placing the device in an invalid state.

10. A method according to claim 1 wherein step (c) further comprises identification of incorrect programmed secure data in the array; and
thereafter reiterating step (b); and
subsequently proceeding to steps (c) through (k).

11. A method according to claim 1 wherein step (c) further comprises identification of incorrect programmed secure data in the array; and
thereafter programming all cells of the array containing secure data, thereby overwriting the secure data; and
proceeding to step (f).

12. A method according to claim 1 wherein step (c) further comprises identification of incorrect programmed secure data in the array; and thereafter proceeding to steps (f) and (i), and following step (i), programming all cells of the array containing the control bit cell, thereby overwriting the secure data, and proceeding to step (j).

13. A method according to claim 1 wherein step (c) further comprises identification of incorrect programmed secure data in the array; and thereafter
proceeding to steps (f) and (i), and following step (i), programming all cells of the array containing the control bit cell, thereby overwriting the device information specific to the IC placing the device in an invalid state, and proceeding to step (j).

14. A method according to claim 1 wherein step (c) further comprises identification of incorrect programmed secure data in the array; and
thereafter programming all cells of the array containing secure data, thereby overwriting the secure data; and
omitting steps (f) and (g), proceeding directly to step (h).

15. A method according to claim 1 wherein step (c) further comprises identification of non-read-protected secure data in the array; and
thereafter omitting steps (f) and (g), proceeding directly to steps (h) and (i), and following step (i), programming all cells of the array containing the control bit cell, thereby overwriting the secure data, and proceeding to step (j).

16. A method according to claim 1 wherein step (c) further comprises identification of non-read-protected secure data in the array; and
thereafter omitting steps (f) and (g), proceeding directly to steps (h) and (i), and following step (i), programming all cells of the array containing the control bit cell, thereby overwriting the device information specific to the IC placing the device in an invalid state, and proceeding to step (j).

17. A method according to claim 1 wherein step (c) further comprises identification of non-read-protected secure data in the array; and
thereafter omitting steps (f) through (i), programming all cells of the array containing the control bit cell, thereby overwriting the secure data, and proceeding to step (j).

18. A method according to claim 1 wherein step (c) further comprises identification of non-read-protected secure data in the array; and
thereafter omitting steps (f) through (i), programming all cells of the array containing the control bit cell, thereby overwriting the device information specific to the IC placing the device in an invalid state, and proceeding to step (j).

19. A method according to claim 1 wherein step (e) further comprises identification of non-read-protected secure data in the array; and
thereafter programming all cells of the array containing secure data, thereby overwriting the secure data; and
proceeding to step (f).

20. A method according to claim 1 wherein step (e) further comprises identification of non-read-protected secure data in the array; and thereafter
proceeding to steps (f) and (i), and following step (i), programming all cells of the array containing the control bit cell, thereby overwriting the secure data, and proceeding to step (j).

21. A method according to claim 1 wherein step (e) further comprises identification of non-read-protected secure data in the array; and thereafter
proceeding to steps (f) and (i), and following step (i), programming all cells of the array containing the control bit cell, thereby overwriting the device information specific to the IC placing the device in an invalid state, and proceeding to step (j).

22. A method according to claim 1 wherein step (e) further comprises identification of non-read-protected secure data in the array; and
thereafter programming all cells of the array containing secure data, thereby overwriting the secure data; and
omitting steps (f) and (g), proceeding directly to step (h).

23. A method according to claim 1 wherein step (e) further comprises identification of non-read-protected secure data in the array; and thereafter
omitting steps (f) and (g), proceeding directly to steps (h) and (i), and following step (i), programming all cells of the array containing the control bit cell, thereby overwriting the secure data, and proceeding to step (j).

24. A method according to claim 1 wherein step (e) further comprises identification of non-read-protected secure data in the array; and thereafter
omitting steps (f) and (g), proceeding directly to steps (h) and (i), and following step (i), programming all cells of the array containing the control bit cell, thereby overwriting the device information specific to the IC placing the device in an invalid state, and proceeding to step (j).

25. A method according to claim 1 wherein step (e) further comprises identification of non-read-protected secure data in the array; and thereafter
omitting steps (f) through (i), and programming all cells of the array containing the control bit cell, thereby overwriting the secure data, and proceeding to step (j).

26. A method according to claim 1 wherein step (e) further comprises identification of non-read-protected secure data in the array; and thereafter
omitting steps (f) through (i), and programming all cells of the array containing the control bit cell, thereby overwriting the device information specific to the IC placing the device in an invalid state, and proceeding to step (j).

27. A method according to claim 1 wherein step (g) further comprises identification of non-write-protected secure data in the array; and
thereafter programming all cells of the array containing secure data, thereby overwriting the secure data; and
proceeding to step (h).

28. A method according to claim 1 wherein step (g) further comprises identification of non-write-protected secure data in the array; and
thereafter proceeding to steps (h) and (i), and following step (i), programming all cells of the array containing the control bit cell, thereby overwriting the secure data; and
proceeding to step (j).

29. A method according to claim 1 wherein step (g) further comprises identification of non-write-protected secure data in the array; and
thereafter proceeding to steps (h) and (i), and following step (i), programming all cells of the array containing the control bit cell, thereby overwriting the device information specific to the IC placing the device in an invalid state; and
proceeding to step (j).

30. A method according to claim 1 wherein step (g) further comprises identification of non-write-protected secure data in the array; and
thereafter omitting steps (h) and (i), and programming all cells of the array containing the control bit cell, thereby overwriting the secure data; and
proceeding to step (j).

31. A method according to claim 1 wherein step (g) further comprises identification of non-write-protected secure data in the array; and
thereafter omitting steps (h) and (i), and programming all cells of the array containing the control bit cell, thereby overwriting the device information specific to the IC placing the device in an invalid state; and
proceeding to step (j).

32. A method according to claim 1 wherein step (i) further comprises identification of incorrect control bit data; and
thereafter programming all cells of the array containing the control bit cell, thereby overwriting the secure data.

33. A method according to claim 1 wherein step (k) further comprises identification of non-write-protected control bit data; and
thereafter programming all cells of the array containing the control bit cell, thereby overwriting the secure data.

34. A method according to claim 1 wherein step (k) further comprises identification of non-write-protected control bit data; and
thereafter programming all cells of the array containing the control bit cell, thereby overwriting the device information specific to the IC placing the device in an invalid state.

35. A method according to claim 1 wherein the series of steps are reiterated for a plurality of arrays.

36. In an electronic device having a plurality of associated programmable and irreversible memory cell arrays, and having a single control bit cell for indicating the programmed state of the plurality of arrays, a method according to claim 1 wherein steps (b) through (g) are reiterated for each of the plurality arrays before proceeding to step (h).

37. A method according to claim 1 wherein step (c) further comprises steps for:
(l) determining whether or not the device supports repair of a programmable and irreversible memory array;
(m) programming of the read-protection fuse on the failing array;
(n) programming of the write-protection fuse on the failing array; and
(o) programming the secure data into a substitute array using the steps (b) through (e).

38. A method according to claim 1 wherein step (e) further comprises steps for:
(l) determining whether or not the device supports repair of a programmable and irreversible memory array;
(m) programming of the read-protection fuse on the failing array;
(n) programming of the write-protection fuse on the failing array; and
(o) programming the secure data into the substitute array using the steps (b) through (e).

39. A method according to claim 1 wherein step (g) further comprises steps for:
(l) determining whether or not the device supports repair of a programmable and irreversible memory array;
(m) programming of the read-protection fuse on the failing array;
(n) programming of the write-protection fuse on the failing array; and
(o) programming the secure data into the substitute array using the steps (b) through (e).

40. A method according to claim 1 further comprising the steps of:
following step (i), disabling the repair capability for all arrays; and
testing the disabled status of the repair capability for all arrays.

41. A method according to claim 40 wherein the step of testing the disabled status of the repair capability further comprises identification of incorrectly disabled repair capability; and
thereafter programming all cells on the array containing the control bit, thereby overwriting the secure data; and then
proceeding to step (j).

42. A method according to claim 40 wherein the step of testing the disabled status of the repair capability further comprises identification of incorrectly disabled repair capability; and
thereafter programming all cells on the array containing the control bit, thereby overwriting the device information specific to the IC placing the device in an invalid state; and then
proceeding to step (j).

43. A method according to claim 40 wherein the step of testing the disabled status of the repair capability further comprises identification of incorrectly disabled repair capability; and
thereafter programming all cells on the array containing the control bit, thereby overwriting the secure data; and then
omitting the remaining steps.

44. A method according to claim 40 wherein the step of testing the disabled status of the repair capability further comprises identification of incorrectly disabled repair capability; and
thereafter programming all cells on the array containing the control bit, thereby overwriting the device information specific to the IC placing the device in an invalid state; and then
omitting the remaining steps.

45. A programmable irreversible memory system comprising:
an electronic device operably coupled to;
at least one memory cell array, the memory cell array comprising a plurality of programmable data cells further comprising;
at least one secure data cell adapted for accepting and storing secure data;
at least one read-protect cell operably coupled to the secure data cells and adapted for selectably permanently preventing reading of the secure data cells;
at least one write-protect cell operably coupled to the data cells and adapted for selectably permanently preventing writing data to the secure data cells; and
at least one control bit cell operably coupled to the secure data cells and adapted for selectably permanently indicating the program state of the memory cell array.

46. A system according to claim 45 wherein the control bit cell further comprises the read-protect cell.

47. A system according to claim 45 wherein the control bit cell further comprises the write-protect cell.

48. A system according to claim 45 wherein the memory cell array further comprises an array of programmable electronic fuses.

49. A system according to claim 45 further comprising a plurality of memory cell arrays, each memory cell array further comprising a plurality of secure data cells, the plurality of memory cell arrays adapted for serial programming with secure data values.

50. A system according to claim 49 wherein each of the memory cell arrays further comprises one or more independently selectable read-protect cell.

51. A system according to claim 49 wherein each of the memory cell arrays further comprises one or more independently selectable write-protect cell.

52. A system according to claim 49 wherein each of the memory cell arrays further comprises one or more independently selectable control bit cell.

53. A system according to claim 49 wherein a single control bit cell is operably coupled to two or more memory cell arrays.
